(19) United States
(12) Patent Application Publication
(10) Pub. No.: US 2015/0016715 A1
(43) Pub. Date: Jan. 15, 2015

(54) OUTPUT DEVICE AND OUTPUT SYSTEM

(71) Applicant: Omron Corporation, Kyoto-shi, Kyoto (JP)

(72) Inventors: Ryo Isago, Tokyo (JP); Goro Komori, Tokyo (JP)

(73) Assignee: Omron Corporation, Kyoto-shi, Kyoto (JP)

(21) Appl. No.: 14/383,849

(22) PCT Filed: Feb. 25, 2013
(86) PCT No.: PCT/JP2013/054742

§ 371 Date: Sep. 8, 2014

(30) Foreign Application Priority Data
Mar. 8, 2012 (JP) 2012-052144

(51) Int. Cl. G06K 9/62; G06K 9/46

(52) U.S. Cl. CPC G06K 9/627; G06K 9/4604
USPC 382/155

(57) ABSTRACT

An output device has a first input portion that inputs data of a target state, a second input portion that inputs data of a current state, a sensing portion that senses a state of a shift portion that shifts from the current state to another state including the target state and generates sensing data, a transmission portion that transmits the sensing data, the data of the target state, and the data of the current state, to a predetermined external device, a reception portion that receives from the external device suitability determination result data acquired by determination of suitability of the shift portion configured to shift from the current state to the target state, based on the sensing data, the data of the target state, and the data of the current state, and an output portion that outputs the suitability determination result data that the reception portion has received.

### BACKGROUND

1. Technical Field

The present invention relates to an output device that outputs various types of information, and an output system that uses the output device.

2. Related Art

Conventionally, a proposal has been made of a system in which overlay information is displayed so as to be superimposed on an image captured with a camera (see Patent Literature 1, for example).

The system disclosed in Patent Literature 1 retrieves information associated with an image captured with a camera, and displays retrieved information so as to be superimposed on a captured image.

### CITATION LIST

### Patent Literature

Patent Literature 1: Japanese Patent Laid-Open Publication No. 2011-55250

### SUMMARY

However, the conventional system only displays relevant information of a captured item and has not displayed information that a user desires.

One or more embodiments of the present invention provides an output device and an output system that output information that a user desires.

An output device according to one or more embodiments of the present invention includes: a first input portion configured to input data of a target state; a second input portion configured to input data of a current state; a sensing portion that senses a state of a shift portion configured to shift from the current state to another state including the target state and generates sensing data; a transmission portion that transmits the sensing data, the data of the target state, and the data of the current state, to a predetermined external device; a reception portion that receives from the external device suitability determination result data acquired by determination of suitability of the shift portion configured to shift from the current state to the target state, based on the sensing data, the data of the target state, and the data of the current state; and an output portion that outputs the suitability determination result data that the reception portion has received.

It is to be noted the “current state” referred to in one or more embodiments of the present invention is defined as a present state of an object to which a target state is set. This current state can be expressed as a point corresponding to the current time on a “state space” as a space configured with one or more variables expressing a state of the object as an axis.

The “target state” shows a position of a target on the state space.

The “another state” is defined as an arbitrary state that can be shifted by a shift portion. As the “another state,” a “target state” can be set or an intermediate state that is a midway stage from a current state to a target state can also be set.

The “shift portion” is a means for shifting from each point on the state space to another point on the state space.

The “suitability” shows whether or not a shift portion suits a route from a position of a current state in the state space to a position of a target state in the state space. The suitability can be described by two values of “suitable” or “unsuitable” or can also be described by a multi-stage value as a degree of suitability.

In an example of a train illustrated in FIG. 1 to FIG. 5, the target state is a destination location to which a railroad user is going. The current state is a current location in which the railroad user is present at the time. In this example of the train, the state space can be described as a four-dimensional space configured by a total of four dimensions consisting of the three dimensions of latitude, longitude, and altitude in addition to one dimension of time. However, a “train operation chart” (train diagram) can also be set as a state space. In the train diagram, a vertical axis indicates a name of a station in a line and a horizontal axis indicates time. In addition, the shift portion is a train that is operated according to a specific operation schedule. The suitability is a degree of suitability of the train that is operated according to the specific operation schedule with respect to a route from the current location to the destination location.

In an example of plant growth illustrated in FIG. 11, the state space is a space configured by two axes of an axis of the size of a plant and an axis of the color of the plant. The target state is a pair of ideal values of the size and color of a plant to be grown. The current state is a pair of current values of the size and color of the plant to be grown. The shift portion in this case is expressed in the combination of temperature, humidity, an amount of water, a type of a fertilizer, and an amount of the fertilizer that are given to the plant at a specific timing. In addition, the suitability of this shift portion may be also set to a value of probability of reaching the target state by the execution of the shift portion in the current state.

In an example of selection of a dish illustrated in FIG. 13, the state space is a space configured by the amount of respective allergy-causing substances and the amount of respective nutritional substances that are contained in a meal. The current state is a state in which both the respective substances are zero due to no meal. The target state is a state in which the respective nutritional substances have a sufficient amount and respective allergy-causing substances are zero. The suitability can be considered as a degree that shows each menu item can be eaten or drunk, or cannot be eaten or drunk, in terms of taking a necessary nutritional substance while avoiding the intake of an allergy-causing substance.

Then, a user captures a direction board with a camera as a sensing means mounted in a mobile phone (the output device of one or more embodiments of the present invention) belonging to the user. The data of a captured image is equivalent to the sensing data.

An external device (server) analyzes image data received from the mobile phone by using a method such as a character recognition function, extracts train information displayed on the direction board, and sets this train information as a feature amount. Then, the external device searches a database and acquires a route from a current station to a destination station from the database. The external device collates a searched and acquired route with extracted train information (the feature amount), and determines suitability. For example, the external device, among a plurality of trains displayed on a captured direction board, determines a train that is suitable for the route. This determination result is transmitted to the mobile phone of the user.

The mobile phone outputs a received determination result. For example, the mobile phone displays text data such as “Platform No. 3, 9:14, Semi-Express, Get off at the fifth station,” and displays information on the train to be taken.

Alternatively, it may be also possible to display on a screen the determination result in association with the shift portion. Particularly, in the image data of the captured direction board, by superimposing and displaying the information of the train to be taken (displaying a mark that shows that the train is available to be taken, for example), the user can intuitively determine which train to take. Furthermore, it is also possible to output the determination result by voice.

It should be noted the extraction of a feature amount may be performed in the server or may be performed in the mobile phone. In addition, it is further possible to employ a mode in which, without the transmission and reception with the external device, all the processes in the server are processed in the mobile phone. In such a case, various types of databases are prepared in the mobile phone.

One or more embodiments of the present invention can make it possible to output information that a user desires.

### BRIEF DESCRIPTION OF DRAWINGS

FIG. 1 is a block diagram showing a configuration of a display system.

FIG. 2 is a view showing an example in a case of capturing a direction board using a display device.

FIG. 3 is a view showing a mode in which information is transmitted from the display device to a server.

FIG. 4 is a view showing an example in which a determination result is superimposed and displayed.

FIG. 5 is a view showing an example in which the determination result is displayed by text data.

FIG. 6 is a view showing the display system in a case of using congestion information.

FIG. 7A is a view showing a station information database and FIG. 73 is a view showing a train information database.

FIG. 8A is a view showing another train information database and FIG. 8B is a view showing a transfer information database.

FIG. 9 is a flow chart illustrating an operation performed by a server 2.

FIG. 10 is a flowchart illustrating an operation performed by the server 2.

FIG. 11 is a view showing a display system according to another example.

### DETAILED DESCRIPTION

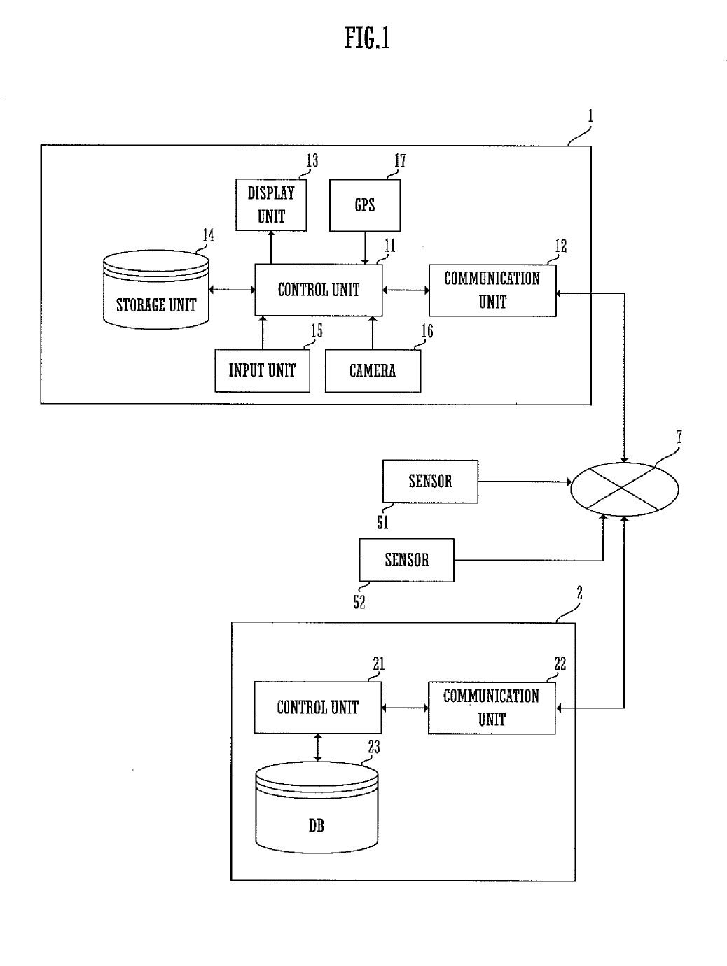

Embodiments of the present invention will be described below with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention. FIG. 1 is a block diagram showing a configuration of a display system provided with a display device that is an example of an output device of one or more embodiments of the present invention. The display system is provided with a display device 1, a server 2, and a plurality of sensors (a sensor 51 and a sensor 52 in the example of FIG. 1), which are connected through the Internet 7.

The display device 1 may be an information processing apparatus such as a mobile phone and a PDA that belong to a user. The display device 1 is equipped with a control unit 11, a communication unit 12, a display unit 13, a storage unit 14, an input unit 15, a camera 16, and a GPS 17. In one or more embodiments of the present invention, as will be described later, the input unit 15 is equivalent to the first input portion defined by one or more embodiments of the present invention and the input unit 15 and the GPS 17 are equivalent to the second input portion defined by one or more embodiments of the present invention. The camera 16 is equivalent to the sensing portion defined by one or more embodiments of the present invention. The communication unit 12 is equivalent to the transmission portion and the reception portion defined by one or more embodiments of the present invention. In addition, the display unit 13 is equivalent to the output portion defined by one or more embodiments of the present invention.

The control unit 11 performs the operations of transmitting various types of data to the server 2 through the communication unit 12 and the Internet 7, receiving the data from the server 2, and displaying received data on the display unit 13.

The server 2 is equipped with a control unit 21, a communication unit 22, and a database (DB) 23.

The control unit 21 receives sensing data that is a result acquired by sensing an object, from the display device 1, the sensor 51, and the sensor 52 and the like through the communication unit 22 and the Internet 7. The sensor includes a camera, a GPS, a temperature sensor, a moisture sensor, an illuminance sensor, and an air pressure sensor and mainly senses the state of the shift portion defined by one or more embodiments of the present invention. These sensors 51 and 52 are also equivalent to the sensing portion defined by one or more embodiments of the present invention. The sensing data may be data (image data and the like) in which a feature amount extracted by processing the sensing data shows the state of the shift portion or may be data (temperature, humidity, illuminance, air pressure, and the like) directly showing the state of the shift portion. It is to be noted, in one or more embodiments of the present invention, the object to be sensed is described as a direction board (a thing that shows information such as the departure time, the destination, a train type, and the platform number of each train) installed at the passenger station of a railroad, and the camera 16 that captures this direction board is described as an equivalent to the sensing portion defined by one or more embodiments of the present invention.

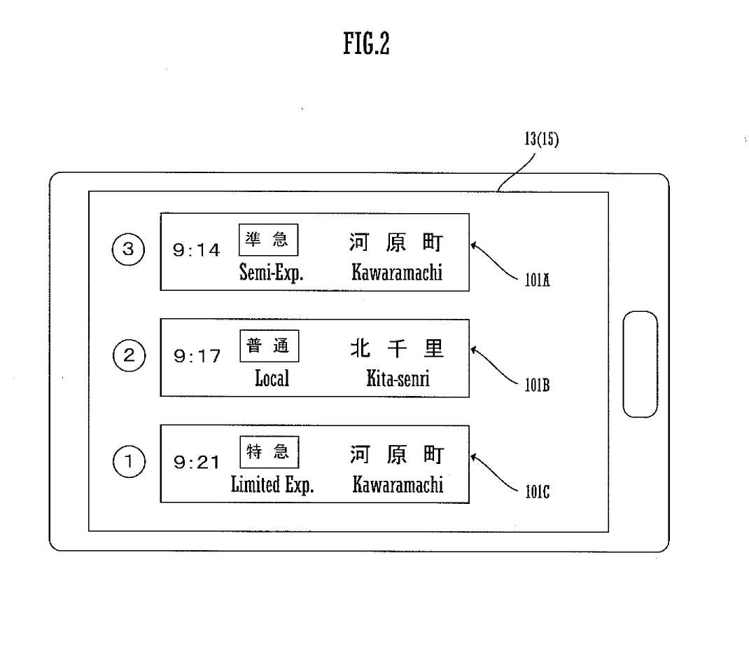

As shown in FIG. 2, the display device 1 is equipped with a touch panel functioning as both the display unit 13 and the input unit 15. A user captures a direction board by using the sensor (camera) 16. In one or more embodiments of the present invention, the image data acquired by capturing the direction board here is equivalent to the sensing data acquired by sensing the state of the shift portion, defined by one or more embodiments of the present invention. Moreover, in one or more embodiments of the present invention, a train is equivalent to the shift portion defined by one or more embodiments of the present invention. The direction board displays train information 101 (101A, 101B, 101C), including the departure time, the destination, the train type, and the platform number of each train. In the example of FIG. 2, three pieces of train information 101A, 101B, and 101C are displayed. In one or more embodiments of the present invention, the departure time, the destination, the train type, the platform number, and the like of each train, which all are shown in the direction board are equivalent to the state of the shift portion defined by one or more embodiments of the present invention. The display device 1 processes the image data acquired by capturing the direction board, and acquires the departure time, the destination, the train type, the platform number, and the like of the train as the state of the shift portion.

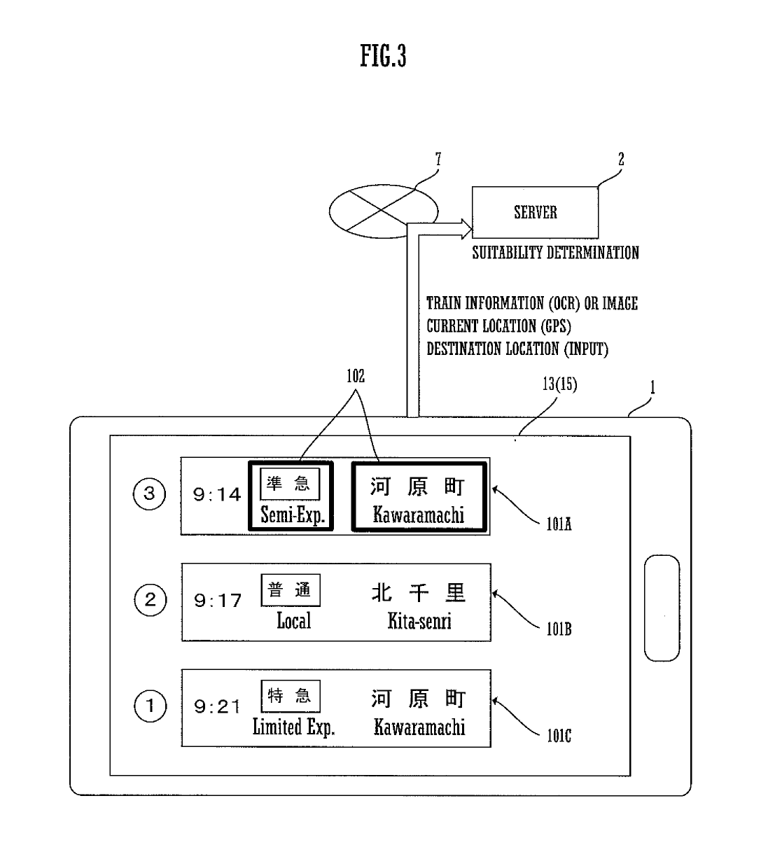

The control unit 11 reads a program stored in the storage unit 14 and extracts a feature amount by pattern recognition. The feature amount is obtained by extracting specific information out of a captured image. In this example, as shown in FIG. 3, the part of “Semi-Exp.” and the part of “Kawaramachi” are extracted by using a character recognition function, and character information 102 is extracted as a feature amount.

Then, the control unit 11 transmits an extracted feature amount to the server 2. It is to be noted a mode in which the data of the captured image is transmitted to the server 2, and the control unit 21 of the server 2 extracts a feature amount may be employed. The extraction of a feature amount by pattern recognition in the display device 1 or the server 2 is equivalent to the feature amount extraction portion defined by one or more embodiments of the present invention. Furthermore, the feature amount extracted here is data that shows the state of a train as the shift portion.

In addition, the control unit 11 transmits the information of a current location and the information of a destination location to the server 2. The information of a current location is station name information that shows a station that is nearest to a current location and is detected by the GPS 17, and is equivalent to the data of a current state defined by one or more embodiments of the present invention. The information of the destination location is station name information that shows a station that is nearest to a destination location inputted by a user, and is equivalent to the data of a target state defined by one or more embodiments of the present invention. The configuration in which the feature amount extracted from a captured image or the captured image in addition to the information of a current location and the information of a destination location is transmitted to the server 2 is equivalent to the transmission portion defined by one or more embodiments of the present invention.

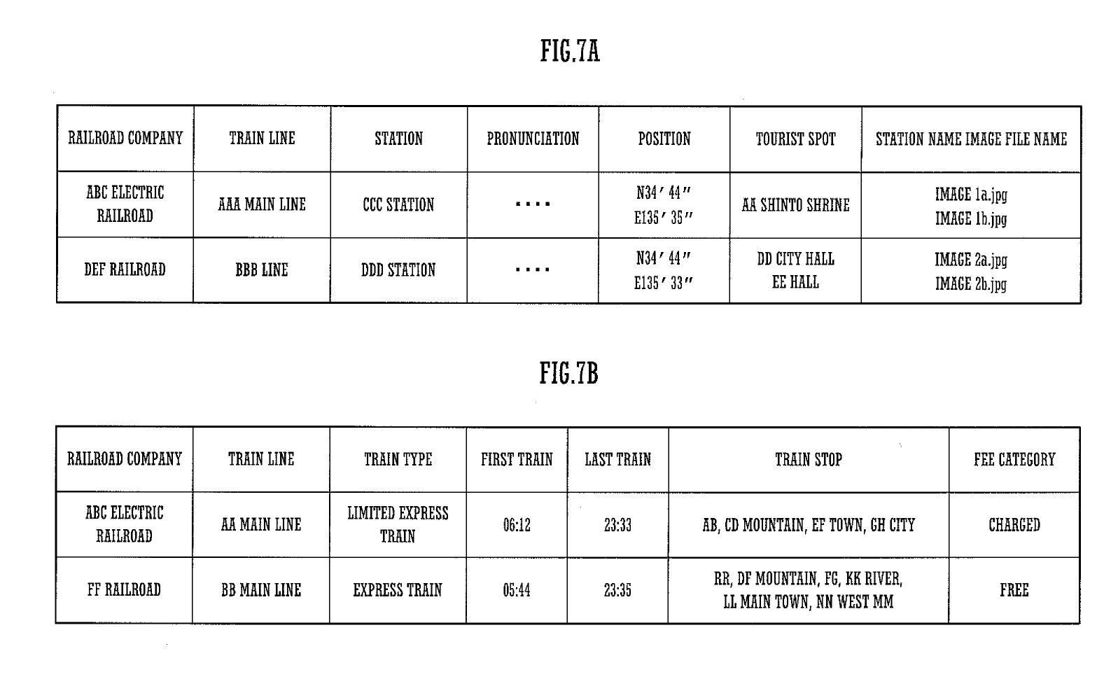

It should be noted, as the information of the current location, for example, station name information of a station nearest to the current location detected by the GPS 17, is automatically selected. Moreover, the display unit 13 may display a list of stations near the current location (less than or equal to a predetermined distance) or such stations may be displayed on a map, which may allow a user to make a selection. Furthermore, lists of railroad companies, train lines, or stations in the station information database (database downloaded from the storage unit 14 or the server 2) as shown in FIG. 7A may be displayed to allow a user to make a selection. Alternatively, a user captures a signboard of a station by using the camera 16, and the control unit 11 may read the name of the station from the image data by using the character recognition function, may display the candidates of stations with the same name on the display unit 13, and may allow the user to make a selection. Additionally, a mode in which a microphone (not shown) equipped with the display device 1 acquires voice of a user so as to receive the input of a station name by speech recognition may be employed. The configuration related to these inputs of the information of the current location is equivalent to the second input portion defined by one or more embodiments of the present invention.

Moreover, as the information of the destination location, lists of railroad companies, train lines, or stations in the station information database (database downloaded from the storage unit 14 or the DB 23 of the server 2) as shown in FIG. 7A may be displayed to allow a user to make a selection. Additionally, a mode in which a microphone (not shown) equipped with the display device 1 acquires voice of a user so as to receive the input of a station name by speech recognition may be employed. The configuration related to these inputs of the information of the target location is equivalent to the first input portion defined by one or more embodiments of the present invention.

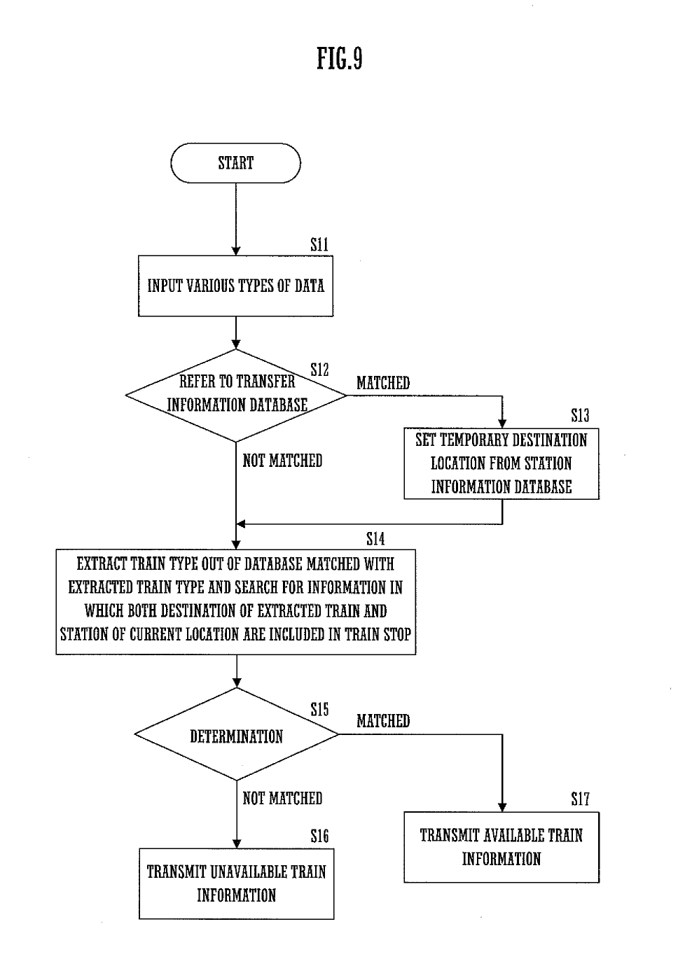

A description is made of the operation of the server 2 with reference to the flow chart of FIG. 9. As shown in FIG. 3, the server 2 receives character information 102 transmitted from the display device 1, the station name information of a current location, and the station name information of a destination location (s11). Then, the server 2 searches the DB 23 for a route from the station of the current location to the station of the destination location, and determines the suitability of a train shown in each piece of character information 102 with respect to the route.

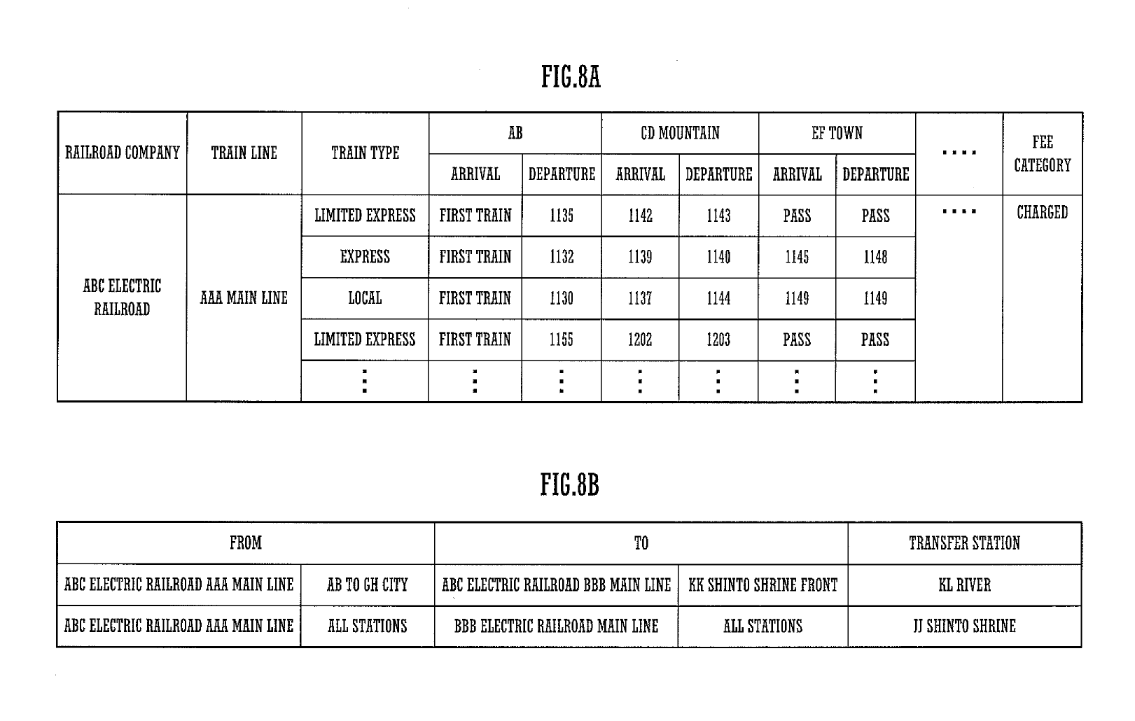

FIG. 7B illustrates an example of a train information database. FIG. 8A illustrates a train information database including an arrival and departure time at each station of each train in addition to the train information shown in FIG. 7B. FIG. 8B illustrates a transfer information database. These databases are stored in the DB 23 of the server 2. These databases are equivalent to the knowledge information defined by one or more embodiments of the present invention, and the DB 23 is equivalent to the knowledge information storage portion defined by one or more embodiments of the present invention.

To begin with, the server 2 refers to the transfer information database (s12). In one or more embodiments of the present invention, the server 2 determines whether or not there is station name information of the current location that matches “From” of the transfer information database and there is also station name information of the destination location that matches “To” of the transfer information database. The server 2, when having determined there is matched station name information, sets a transfer station described in the transfer information database as a temporary destination station (s13).

Subsequently, the server 2 extracts a train of which type matches the train type shown in received character information 102, from the train information database of FIG. 7B or FIG. 8A. In searching the train information database of FIG. 8A, a departure time is also extracted from the train information 101 (101A, 101B, 101C) and is collated with the departure time of the train information database (s14).

Additionally, the server 2 searches the train information database of FIG. 7B or FIG. 8A for information in which a destination station name shown in the character information 102, a station name of the current location, and an objective station name are included in a train stop (s14).

Thus, the server 2 determines the suitability (whether or not to reach a destination location) between the route to the objective station acquired by searching the DB 23 and each train of the character information 102 (s15). The above stated configuration in which a route to the objective station is acquired is equivalent to the route acquisition portion defined by one or more embodiments of the present invention. In a case in which there is character information 102 matched with all in the train information database in s14, the server 2 transmits available train information as a determination result to the display device 1 (s17) while, in a case in which there is no matched character information 102, the server 2 outputs unavailable train information as a determination result to the display device 1 (s18). These determination results are equivalent to the suitability determination result data defined by one or more embodiments of the present invention. In addition, a determination process for obtaining these determination results is equivalent to the suitability determination portion defined by one or more embodiments of the present invention.

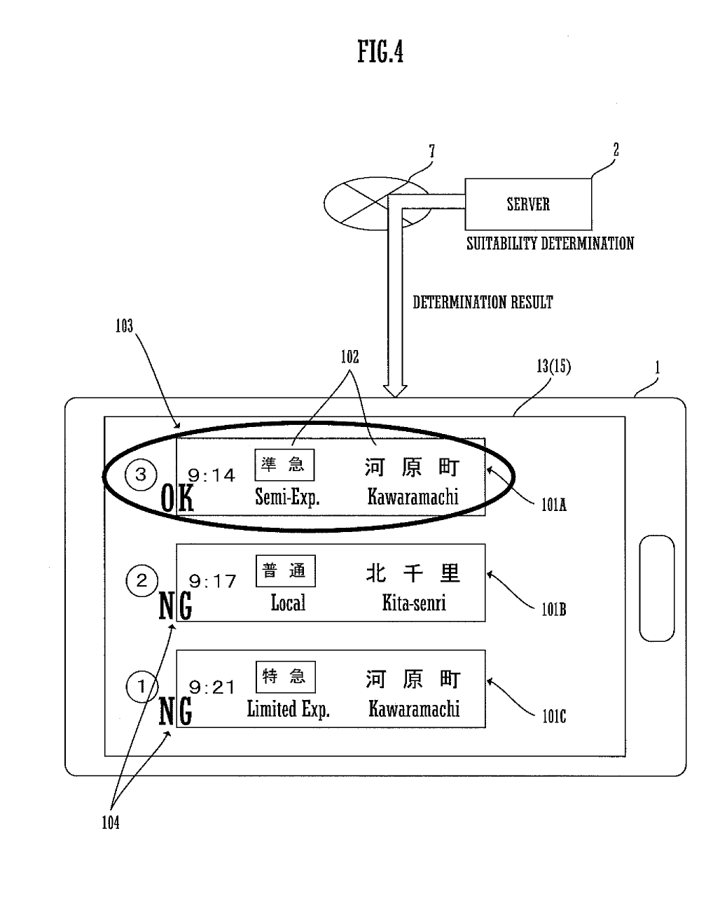

The display device 1 receives these determination results from the server 2 and displays the determination results on the display unit 13. This configuration in which the determination results are received is equivalent to the reception portion defined by one or more embodiments of the present invention, and the configuration in which the determination results are displayed on the display unit 13 is equivalent to the output portion defined by one or more embodiments of the present invention. For example, according to one or more embodiments of the present invention, as shown in FIG. 4, when receiving the available train information, the display device may display an available train mark (OK mark) 103 by superimposing the mark on the train information 101A corresponding to the character information 102 that the available train information shows. When receiving the unavailable train information, according to one or more embodiments of the present invention, the display device may display an unavailable train mark (NG mark) 104 by superimposing the mark on the train information 101B and the train information 101C corresponding to the character information 102 that the unavailable train information shows.

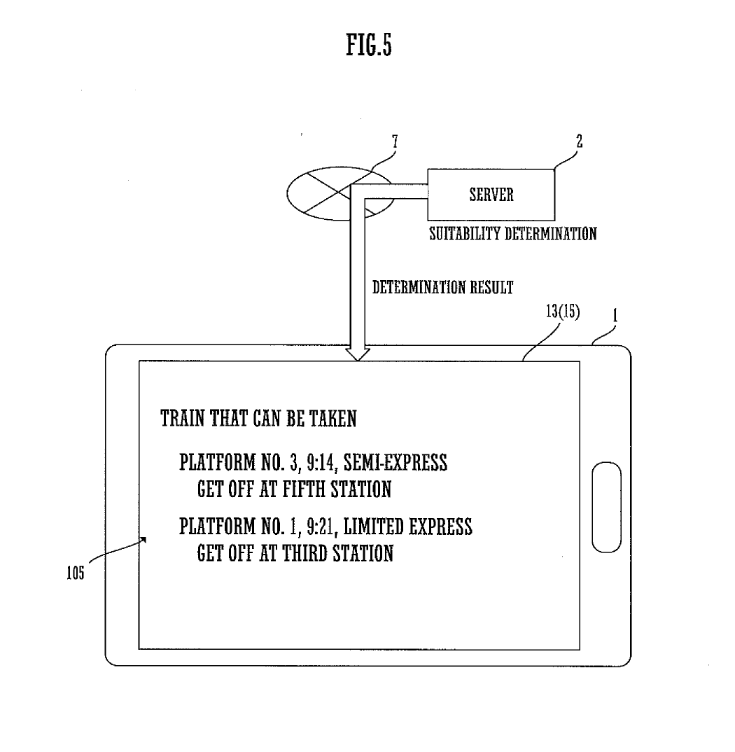

Alternatively, as shown in FIG. 5, a mode in which text data such as “Platform No. 3, 9:14, Semi-Express, Get off at the fifth station” is generated and displayed so as to display the information of a train to be taken can be employed.

In this way, a user only captures a direction board with a camera 16 and can easily determine whether or not each train is a train to be taken. It is to be noted even if a user captures (senses) with the camera 16 the display of a train type (a local, a semi-express, for example), a destination, and a train number that are displayed on the side of the train that stops at the platform of a station, similarly to the case of capturing the direction board, the available train mark (OK mark) 103 or the unavailable train mark (NG mark) 104 can also be displayed as a determination result by superposing the mark on an image on the side of the train. In addition, the same is applicable to not only a train but also a bus.

It should be noted, as shown in FIG. 7B and FIG. 8A, the train information database includes information that shows a free or charged category. For example, when selecting the station name of a current location, and the station name of the destination location, “use of a charged train,” “no use of a charged train,” and the like is selected, so that information selected in this way is transmitted to the server 2 and used for collation with the train information database. Thus, a user can specify various types of conditions for use in the determination of suitability.

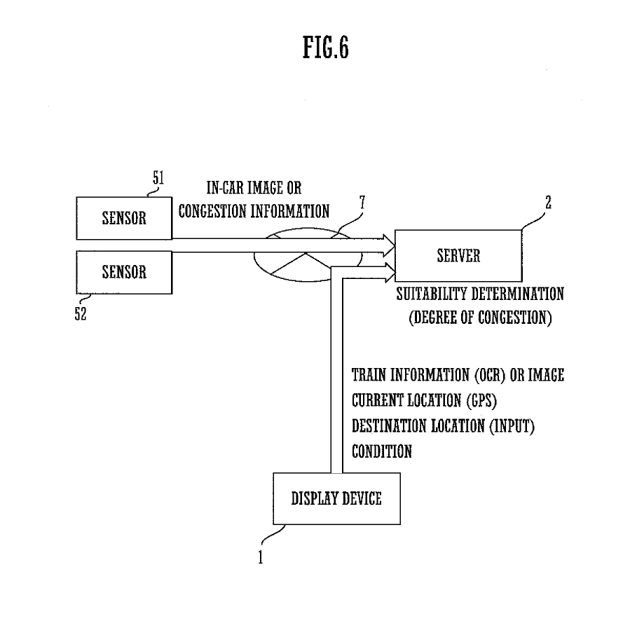

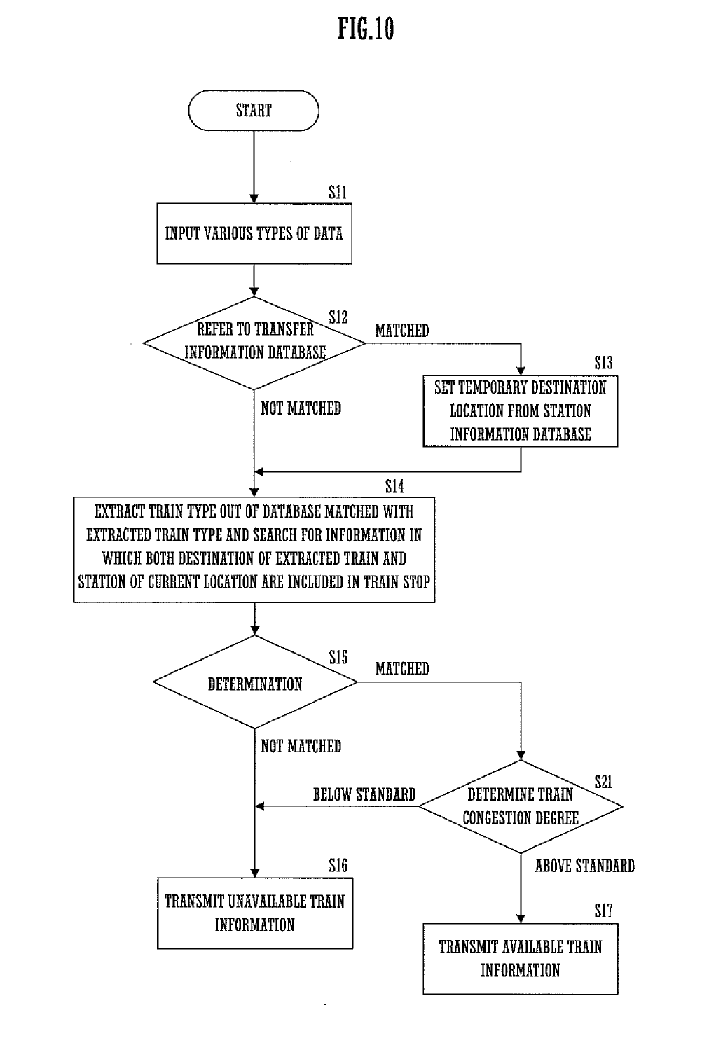

For example, as shown in FIG. 6 and FIG. 10, the degree of congestion of a train can be used for the determination of suitability. It is to be noted, in the flow chart shown in FIG. 10, the parts common with FIG. 9 are given the same reference numerals and descriptions of the parts are omitted.

In this example, the information that specifies the degree of congestion specified by a user is transmitted from the display device 1 to the server 2. The degree of congestion, for example, when selecting the station name of a current location or an objective station name, is generated by selecting “in consideration of the degree of congestion of a train,” “in no consideration of the degree of congestion of a train,” and the like. The selected information is transmitted to the server 2 and is used for collation with the train information database.

Additionally, to the server 2, an in-car image of a train or information that shows a degree of congestion from the sensor 51 and the sensor 52 is transmitted. When the in-car image is transmitted, the server 2 converts the image into information that shows the degree of congestion. The information that shows the degree of congestion, for example, is generated by first extracting an image of a passenger from an image in a train and then calculating the occupancy of the image of the passenger in the whole of the image, and is shown as a degree of congestion by setting a no passenger state as 0% and the maximum as 100%.

The server 2, as shown in FIG. 10, determines the suitability (whether or not to reach a destination location) of each train in s15 and, after having determined there is a matched train, performs the determination of a degree of congestion of the train (s21). For example, in a case in which the degree of congestion exceeds 50%, the degree of congestion is determined below the standard and thus the unavailable train information is outputted as a determination result to the display device 1 (s18). Only in a case in which the degree of congestion is less than 50%, the available train information is transmitted to the display device 1 as a determination result (s17).

It should be noted the sensor 51 and the sensor 52 may be fixed cameras installed in each train and may have a mode in which the sensor automatically transmits data to the server 2, or a mode in which a train passenger manually captures the inside of a train by using a mobile phone or the like belonging to the user or a mode in which a degree of congestion is inputted may be employed. Moreover, in the case of manually inputting the degree of congestion, it is desirable to allow a user to select the train that the train passenger is now on among previously specified pieces of train information.

Furthermore, with a mobile phone equipped with the GPS, it is also possible to employ a mode in which latitude and longitude information is transmitted to the server 2. In such a case, the server 2 can search for a relevant train with reference to the train information database by using received latitude and longitude information and a time when the information is received, and thus can obtain the degree of congestion of each train.

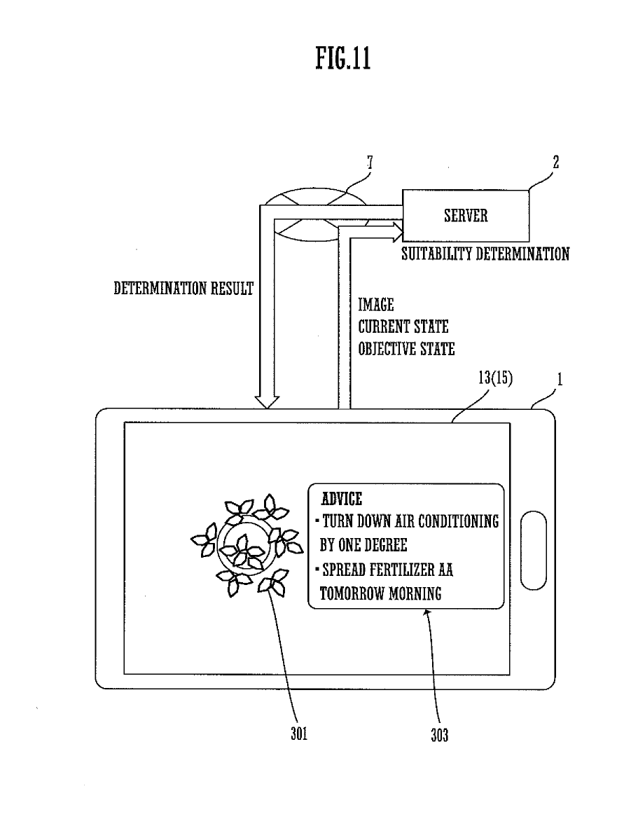

Subsequently, FIG. 11 is a view showing a display system according to another example. In this example, a user captures a plant by using the sensor (camera) 16.

The control unit 11 extracts the growth situation of a plant 301 as a feature amount of image data. The growth situation is obtained by a difference from a previously captured image, a distance from the ground, an occupancy rate of green color, and the like. The information that shows the growth situation is transmitted to the server 2. Alternatively, the control unit 11 may transmit image data to the server 2 and may cause the server 2 to extract the growth situation. In this example, temperature data and humidity data are also extracted as sensing data.

In addition, the control unit 11 transmits the data of a current state and also the data of a target state to the server 2. The data of the current state in this example is the number of growing days after planting the plant, for example. The data of the target state is an ideal size or color of the plant, for example. If the plant is an edible plant, the target state is a state in which the plant is ready to be eaten. Moreover, the shift portion in this example is equivalent to temperature, humidity, the type of water or a fertilizer, the amount of a fertilizer, and the like that are given to the plant. Temperature data or humidity data as sensing data is data that directly shows the state of the shift portion.

The server 2 receives data showing the growth situation, the number of growing days, and the target state of the plant that are transmitted from the display device 1. Then, the server 2 searches the DB 23 for a route (temperature, humidity, and when and which timing a fertilizer is given, for example) for shifting from the current state of the plant to the target state of the plant. In this example, the DB 23, for each plant name, accumulates data showing the optimal temperature, the optimal humidity, a standard size, a fertilizer type, an amount of a fertilizer, on each growing day. The server 2 determines the suitability of the growth situation with respect to the route. In this example, as the suitability, measures for making the current situation change to the most suitable situation in which a plant grows and reaches target state are required. For example, information that a temperature should be lowered by one degree is required. Alternatively, information that shows the type of a fertilizer and a timing when the fertilizer should be given (a fertilizer AA is to be spread tomorrow morning, for example) is required. These pieces of information are equivalent to the suitability determination result data defined by one or more embodiments of the present invention.

It is to be noted a case in which the state space is a space configured with two axes of the axis of a plant size and the axis of a plant color may also be considered. In such a case, the target state may be a pair of ideal values of the size and color of a plant to be grown. The current state is a pair of current values of the size and color of the plant to be grown. The shift portion is expressed by the combination of temperature, humidity, the amount of water, the type of a fertilizer, and the amount of the fertilizer that are given to the plant at a specific timing. The suitability can also be set to a value of the probability of reaching the target state by executing the shift portion (giving a predetermined amount of water and a specific fertilizer at a specific timing) in the current state.

The display device 1 receives the above stated information (information of lowering a temperature by one degree or information of spreading a fertilizer AA tomorrow morning, for example) from the server 2, and displays such information on the display unit 13. For example, according to one or more embodiments of the present invention, as shown in FIG. 12, “Turn down air conditioning by one degree and spread a fertilizer AA tomorrow morning” as advice information 303 may be displayed so as to be superimposed on the plant 301. Naturally, it is also possible to employ a mode in which text data is generated and the advice information is displayed separately from the plant 301.

Thus, a user only captures a plant with a camera 16 and can easily determine measures for raising a plant to an target growth situation.

It is to be noted, while, in the above described examples, a determination result is displayed on the display unit 13, the output form of this determination result is not limited to such a display and the determination result may be outputted by voice or may be outputted in an output form other than this form.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### REFERENCE SIGNS LIST

1 Display device
2 Server
7 Internet
11 Control unit
12 Communication unit
13 Display unit
14 Storage unit
15 Input unit
16 Camera
17 GPS
21 Control unit
22 Communication portion
23 DB
51 Sensor
52 Sensor

1. An output device comprising:
a first input portion that inputs data of a target state;
a second input portion that inputs data of a current state;
a sensing portion that senses a state of a shift portion that shifts from the current state to another state including the target state and generates sensing data;
a transmission portion that transmits the sensing data, the data of the target state, and the data of the current state, to a predetermined external device;
a reception portion that receives from the external device suitability determination result data acquired by determination of suitability of the shift portion configured to shift from the current state to the target state, based on the sensing data, the data of the target state, and the data of the current state; and
an output portion that outputs the suitability determination result data that the reception portion has received.

2. An output device comprising:
a first input portion that inputs data of a target state;
a second input portion that inputs data of a current state;
a sensing portion that senses a state of a shift portion that shifts from the current state to another state including the target state and generates sensing data;
a feature amount extraction portion that extracts a feature amount from the sensing data;
a transmission portion that transmits the feature amount, the data of the target state, and the data of the current state, to a predetermined external device;
a reception portion that receives from the external device suitability determination result data acquired by determination of suitability of the shift portion that shifts from the current state to the target state, based on the feature amount, the data of the target state, and the data of the current state; and
an output portion that outputs the suitability determination result data that the reception portion has received.

3. The output device according to claim 1, wherein the output portion outputs the suitability determination result data in association with the shift portion.

4. The output device according to claim 3, wherein the output portion displays the suitability determination result data superimposed on a captured image of the shift portion.

5. The output device according to claim 3, wherein the output portion outputs the suitability determination result data as information generated based on the shift portion.

6. An output system comprising:
a first input portion that inputs data of a target state;
a second input portion that inputs data of a current state;
a sensing portion that senses a state of a shift portion configured to that shifts from the current state to another state including the target state and generates sensing data;
a feature amount extraction portion that extracts a feature amount from the sensing data;
a knowledge information storage portion that retains a plurality of pieces of knowledge information that can be used to acquire information of a route from the current state to the target state;
a route acquisition portion that searches the knowledge information storage portion and acquires the information of the route from the current state to the target state based on the data of the target state and the data of the current state;
a suitability determination portion that, based on the feature amount, determines suitability of the shift portion with respect to the information of the route that the route acquisition portion has acquired; and
an output portion that outputs suitability determination result data as a determination result of the suitability determination portion.

7. The output system according to claim 6, wherein the output portion outputs the suitability determination result data in association with the shift portion.

8. The output system according to claim 7, wherein the output portion displays the suitability determination result data superimposed on a captured image of the shift portion.

9. The output system according to claim 7, wherein the output portion outputs the suitability determination result data as information generated based on the shift portion.

10.-15. (canceled)

16. The output device according to claim 2, wherein the output portion outputs the suitability determination result data in association with the shift portion.

17. The output device according to claim 16, wherein the output portion displays the suitability determination result data superimposed on a captured image of the shift portion.

18. The output device according to claim 16, wherein the output portion outputs the suitability determination result data as information generated based on the shift portion.
